(19) United States
(12) Patent Application Publication
(10) Pub. No.: US 2006/0163290 A1
(43) Pub. Date: Jul. 27, 2006

(54) Volumetric displacement dispenser

(76) Inventor: Vincent Ehret, Mt. Prospect, IL (US)

Correspondence Address: LEVENFELD PEARLSTEIN;Intellectual Property Department, 2 North LaSalle, Suite 1300, CHICAGO, IL, 60602, US

(21) Appl. No.: 11/332,277

(22) Filed: Jan. 13, 2006

Related U.S. Application Data
(60) Provisional application No. 60/647,610, filed on Jan. 27, 2005.

(51) Int. Cl. B67D 5/42

(52) U.S. Cl. 222/386.5; 222/401; 222/464.2

(57) ABSTRACT

The present invention, a volumetric displacement dispenser comprising a cap assembly, which further comprises a air pump/air vent assembly in communication with a volumetric displacement device; a liquid dispensing valve having an outlet connected to a spigot and inlet connected to a liquid discharge tube, which is in contact with the dispensable liquid; and a ported stopper whereby the liquid discharge tube and the volumetric displacement dispenser device are maintained in isolated contact with the dispensable liquid. The fluid in the container, once opened, is sealed with the volumetric displacement dispenser wherein the bulk of the atmosphere over the fluid is evacuated as the volumetric displacement dispenser device is inflated by atmospheric air. A small volume of liquid serves to seal the outlet check valve assembly closed. This serves to create a vacuum effect within the container, so that upon dispensing the liquid, a vacuum is applied to the liquid side of the volumetric displacement dispenser device, which causes it to expand, drawing air into its internal volume in an effort to maintain equilibrium with the atmospheric pressure. As a function of this expansion, air is excluded from the container thereby protecting the contents from oxidation.

This application claims the benefit of U.S. Provisional Patent Application Ser. No. 60/647,610, filed on Jan. 27, 2005.

### BACKGROUND OF THE INVENTION

1. Field of the Invention

The present invention specifically relates to a volumetric displacement dispenser to provide the individual user the capability of dispensing a given quantity of wine or other beverage and allowing the storage of the beverage over an extended period of time through the exclusion of air; thus reducing degradation of the container contents whereby the desirable characteristics of the beverage are preserved in their original state. The volumetric displacement dispenser comprises an air pump, check valves and an expandable polymer operative balloon of sufficient gauge and material whereby the balloon expands easily to fill a void occasioned by removal of wine from the wine container. The air pump in cooperation with the check valves operates to expand the operative balloon to dispense wine from the container by pressure of the expanded operative balloon.

2. Description of the Related Art

An effective means for preserving wines and other beverages, once they have been initially decanted, has long been a problematic issue that has confronted the consumer of these commodities. Due to the broad spectrum of liquid commodities negatively impacted by prolonged exposure to air, the discussion of the related art centers about the preservation of wine.

Wine has long been recognized as a valued commodity that has transcended ancient times to present. Due to the chemical composition of wine, it is especially susceptible to degradation via oxidation processes that pose the risk of spoiling the flavor and bouquet in the short term and converting it to a less desirable product, vinegar in the long term. Through the ages, there have been various attempts to develop an acceptable solution to this dilemma, wherein the preservation of foodstuffs was essential to trade and commerce, and daily aspects of life in ancient civilization. This point was further exacerbated given the fact that few control means existed to mitigate the degradation of wine from the extremes of environment. The most popular means of preserving wines was by limiting exposure to air (corking) and the addition of stones or oil and storing the wine in a cool area where exposure to sunlight was limited. In each of these methods, the container contained excess air and did not preserve the quality of the wine. Moreover, diffusion of air through the cork plays a role in the aging of the wine. A balance is required between amount of air required in the aging process and excess air beyond that required in aging. Advances as using wax to prevent entrance of air through the voids of the cork improved the sealing properties of corking. However, without removal of air in void space above the wine's surface, the wine was still subject to degradation. Stones or oil were introduced into the container to displace the air by displacement of the void volume. But each volume displacement method introduced new contaminants, (dirt, oil, bacteria, etc.) to the wine, which impaired the quality of the stored wine. Also, volume replacement by stones, glass or other solid media increased weight of the container, creating transportation problems. This method moreover served to negatively impact taste and body of the wine as bacteria and contaminants, which reacted with the wine, were introduced to the wine by the volume replacement objects. The use of oil as a volume replacement means served only slightly better as increased difficulty in decanting the wine had to be addressed. The need to completely extract the contents of the container required specialized extraction means as siphoning or use of unique containers to prevent the oil from being decanted with the wine. Another problem was that trace amounts of the oil were incorporated into the wine causing an oily taste and sometimes affecting the bouquet. The use of oils having relatively high paraffin contents and waxes solved some of the issues of separation. But, issues with decanting and contaminants still persisted.

A search for practical means of solving these issues has spawned a number of approaches. Some solutions relied on void volume reduction or sealing technology and means for introducing an inert gas to displace the air in the void space and removal of air by creating a vacuum.

Systems that use an inert gas are represented by Ellis, U.S. Pat. No. 4,984,711 wherein the wine dispenser utilizes a piercing means blanketed by an inert gas to avoid introduction of oxygen; thus, preserving the wine in its original state. This approach is both expensive and cumbersome to use, as the individual user expends additional effort in installing the dispenser on an uncorked bottle of wine. The installation is performed under pressure of the inert gas to prevent entrance of air. This can be a potential risk for the individual user, as the cork may be suddenly expelled and the contents discharged. It is noted that the Ellis '711 invention is limited to corked bottles and teaches no preservation technique for previously uncorked wines.

Sitton U.S. Pat. No. 4,856,680 discloses preservation of a dispensed wine product by introducing the wine bottle and the remaining contents into a sealed container, wherein an inert gas such as nitrogen at a pressure exceeding 20 psig is introduced to purge the oxygen from the container. The container is then refrigerated and the contents of the bottle are withdrawn under pressure. This affords the user the possibility of preserving the wine for up to four to six weeks and preventing further aging of the wine. The Sitton '680 patent teaches use of a sealed container for the wine container and inert gas. This system though effective does not readily lend itself to those occasions when a consumer entertains a small party and it would be desirable to decant the wine by hand from the container.

Another popular methodology that has been employed has been the use of the beverage in a bag. U.S. Pat. No. 3,365,202 teaches application of pressure to a flexible bag containing a liquid to dispense the liquid contained therein. Although this patent teaches decanting the liquid within the bag through a decrease in volume obtained through external force, this patent does not address the problem of air entrance into the previously decanted liquid container.

Several patents attempt to solve this problem by inserting an inert gas through the cork stopper and extracting the wine without removing the cork. U.S. Pat. No. 3,883,043 to Lane and U.S. Pat. No. 4,011,971 to Haydon disclose devices utilizing a hollow needle inserted through the bottle cork to withdraw the wine and to introduce an inert gas into the void space above the wine. However, the insertion of the hollow needle through the bottle cork can introduce air into the void space above the wine level and cause deterioration of the contained wine. Also, as Sutton '680 teaches, as most beverages and wines are stored in glass containers, the amount of pressure that can be applied to the container is limited.

Another attempt at preservation extensively employed by many consumers of wines has been the use of devices to draw the air out of a bottle subsequent to re-corking the bottle. However, the success of this system has been variable, as a number of physical parameters limit the effectiveness of this technique. These parameters are the ability to induce a sufficient vacuum to reduce the volume of air in the bottle, the ability to maintain a vacuum once achieved and the ability to indicate when the required vacuum has been obtained. As these devices rely on the penetration of the stopper, even given the compressive qualities of corks, rubber and other materials used as stoppers, it is difficult to maintain a required vacuum for any length of time. Further, since wines are slowly aged in their bottles through the diffusion of oxygen through corks, changing the parameters of the cork would tend to shift the diffusion dynamics toward oxidation of the wine. Another shortcoming of this approach is the failure to foresee the trend of winemakers away from cork and toward plastic lined metal screw caps, which will not work with these systems.

Given the shortcomings and disadvantages of existing approaches to preserving wines and other dispensable liquids impacted by the effects of oxygen, an affordable and convenient means is desirable to preserve the quality of once-opened containers of wine from the harmful effects of ambient atmosphere. The invented device and method provides a means to preserve the quality and bouquet of a wine and prevent further aging of the wine by minimizing introduction of air into the wine container and causing an occupation of the void space within the container by an expandable displacement dispenser that serves to protect the contained wine from contact with the ambient atmosphere.

It is according an object of this invention to provide a wine preservation and dispensing system for bottled wine to allow wine to be dispensed from the bottle by the glass while protecting the wine in the bottle from the harmful effects of being exposed to the ambient air.

It is therefore an object of this invention to provide a bottle cap assembly comprising (a) an air pump or a source of compressed gas, (b) air and liquid check valves, (c) an operative expandable polymer balloon, (d) a liquid discharge tube, (e) a casing for the operative expandable polymer balloon, and (f) a separate cap for the bottle cap assembly, associated tubing, retaining clips and connectors which, in combination, operate as a volumetric displacement dispenser of wine from a bottled container of wine.

It is another object of this invention to provide a dispenser for wine bottles, which provides a volumetric displacement balloon of sufficient flexibility to occupy the void space within a wine container caused by removal of decanted wine, which balloon is caused to expand by suction from the removal of wine from the container and the atmosphere air pressure which enters into the balloon through the bottle cap assembly.

It is another object of this invention to provide an alternative source of compressed gas versus an air pump to cause the operative balloon to expand to occupy the void space in a wine container between the liquid and the container.

It is another object of this invention to provide a method for insertion of the volumetric displacement dispenser into a wine bottle while protecting contents of the bottle from ambient air.

### SUMMARY OF THE INVENTION

This invention relates to a device and method for dispensing a beverage from a bottle container and preserving the contents from the harmful effects of air upon the contents of the bottle. The device is specifically termed a volumetric displacement dispenser. The volumetric displacement dispenser is utilized in lieu of a cork or other closure for a container so as to preserve dispensable liquids, wines or other perishable commodities, wherein the liquids have a prolonged shelf life as the deleterious effects of oxygen are mitigated. The use of the volumetric displacement dispenser comprising check valves, loop seals and an expanding operative balloon allows the individual user to readily dispense the liquid contained within the container without need to recork, purging the container of air, or evacuating the atmospheric contents of the container as a function of dispensing the liquid. Recognizing the need for convenience and ease of use, the volumetric displacement dispenser operative balloon operates at atmospheric pressure. The check valves and loop seal permit liquids or gases to flow only in one direction and thus prevent loss of pressure on liquids or gases. Only a minimum of applied pump pressure is applied to insure that the volumetric displacement dispenser operative balloon obtains initial contact with the surface of the fluid therein. This serves to purge a small volume of the dispensable liquid to insure a liquid full system. Thereafter, whenever the liquid dispensing valve is opened and the fluid is decanted, atmospheric air is drawn into the volumetric displacement operative balloon by extraction of wine from the container. The volumetric displacement operative balloon is sufficiently flexible to occupy the void caused by the removal of the decanted wine. As air fills the volumetric displacement operative balloon, the space within the container is filled and entrance of oxygen restricted. Transparent tubing in the cap assembly can provide visual confirmation to the user that the system is liquid full.

### DESCRIPTION OF THE DRAWINGS

FIG. 1 illustrates an embodiment of the invention wherein an air pump is affixed to an air inlet in the cap assembly to pump air into the volume displacement dispenser operative balloon and an air/gas check valve is operable in the air/gas pressure tube to the operative balloon and a check valve is operable in the liquid discharge tube.

FIG. 2A illustrates the details of the embodiment of FIG. 1.

FIG. 2B illustrates an alternative embodiment of the invention of FIG. 1 wherein the liquid discharge tube uses a loop seal in place of a check valve.

FIG. 3 illustrates an alternative embodiment of the instant invention wherein an external source of a compressed gas is applied to pressure the operative balloon to expand.

FIG. 4 illustrates the details of the embodiment of the cap of FIG. 3.

FIG. 5 illustrates the further details of the embodiment of FIG. 3.

### DETAILED DESCRIPTION OF THE INVENTION

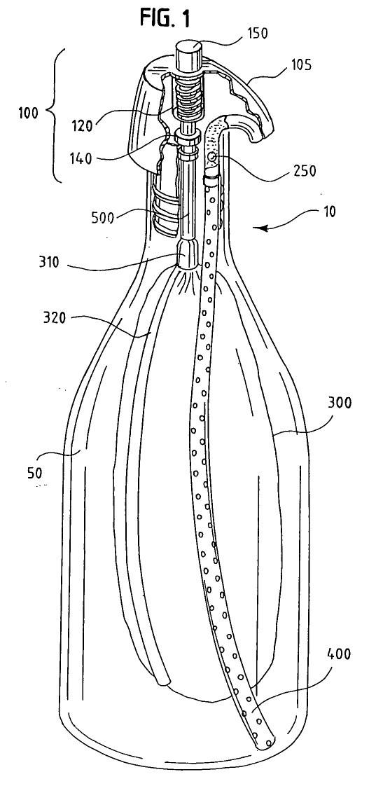

Referring to FIGS. 1-5, the Figures illustrate two embodiments of the volumetric displacement dispenser device comprising a flexible inflatable operative balloon and means permitting liquids and gases to flow only in one direction.

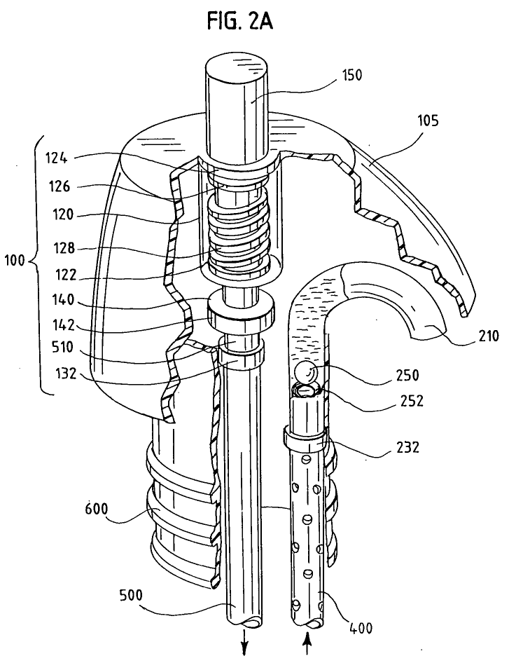

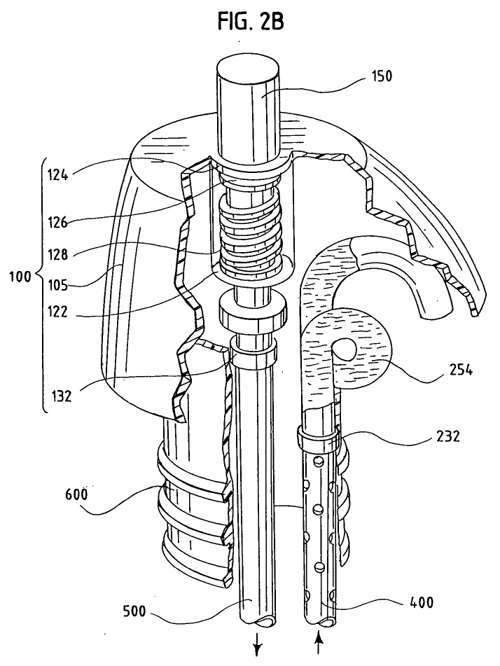

Referring to FIGS. 1-2A, volumetric displacement dispenser 10 is illustrated as inserted in a bottle 50 by ported stopper 600 wherein components of said dispenser 10 comprise a cap assembly 100. Cap assembly 100 comprises cap-air pump 105 with one aperture on the top surface for air pump piston shaft 150 and further comprises air pump/air vent assembly 120 connected to air/gas pressure tube 500 with air/gas check valve 140 inserted therein. Cap assembly 100 further comprises a liquid discharge tube 400 wherein liquid check valve 250 is inserted therein. Volumetric displacement device casing 320 is retained by retaining clip 310 on air/gas pressure tube 500. Volumetric displacement operative balloon 300 is also connected to air/gas pressure tube 500 by retaining clip 310. Air pump piston shaft 150 comprising an air pump means is positioned on piston 126 of air pump/air vent assembly 120 to pump air into volumetric displacement operative balloon 300 as required.

Referring to FIG. 2A, the details of the embodiment of cap assembly 100 of FIG. 1 are illustrated. Air pump/air vent body 122 contains air pump piston shaft 150 positioned on air pump/air vent assembly 120, which comprises piston 126 and piston spring 128. Air/gas check valve 140 containing air check valve flapper 142 is interposed between air pump/air vent assembly 120 and air/gas pressure tube 500 to prevent backflow and to control air injected into volumetric displacement device operative balloon by operation of air pump/air vent assembly 120. Retainer 124 seats air pump piston shaft 150 on air pump/air vent assembly 120. Inlet air connector 132 secures pressure tube inlet 510 to air/gas pressure tube 500. Liquid discharge tube 400 with perforations and air/gas pressure tube 500 are inserted through fitted bores in ported stopper 600. Discharge tube connector 232 secures liquid discharge tube 400 to liquid check valve 250 comprising liquid check valve seat 252 to liquid spigot 210.

FIG. 2B illustrates an alternative embodiment of the volumetric displacement dispenser of FIG. 1 wherein a loop seal 254 is used in liquid discharge tube 400 instead of liquid check valve 250 and liquid check valve seat 252 as in FIG. 2A. All other details are as illustrated in FIG. 2A.

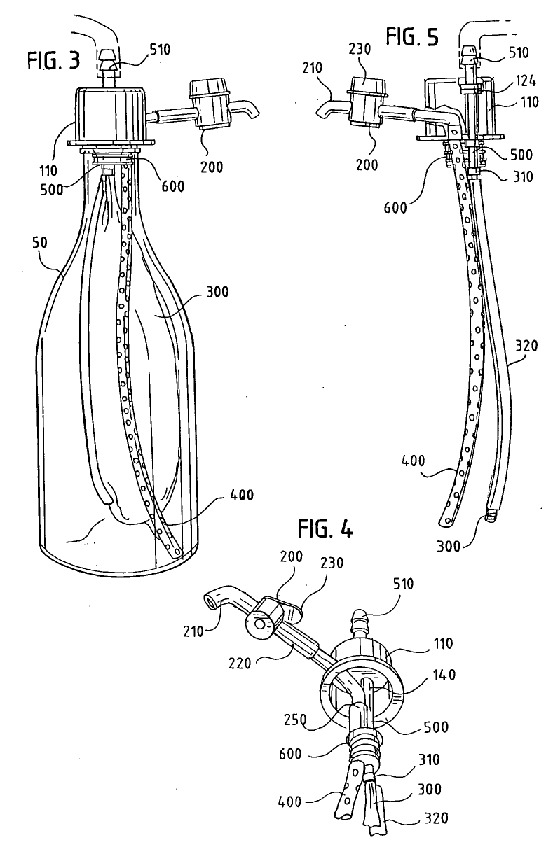

FIGS. 3-5 illustrate an alternative embodiment of volumetric displacement dispenser 10 inserted in bottle 50 by ported stopper 600 wherein an external inert gas under pressure supplies pressurized gas to volumetric displacement operative balloon 300 through pressure tube inlet 510 and retainer 124 to volumetric displacement operative balloon 300. Volumetric displacement operative balloon 300 is positioned on air/gas pressure tube 500 by retaining clip 310, which also retains volumetric displacement device casing 320 which encompasses operative balloon 300 to insert operative balloon 300 into bottle 50. Cap-external gas 110 of the alternative embodiment has two apertures, one on the top surface for pressure tube inlet 510 and one on the side surface for dispensing liquid outlet 220. Liquid outlet 220 dispenses liquid as per dispensing valve operator 230 by liquid dispensing valve 200 by liquid spigot 210 attached thereto.

The expandable operative balloon 300 is essential for application of the volumetric displacement dispenser device. As an operative element of the volumetric displacement dispenser device, the expandable volumetric displacement operative balloon 300 is essential for the physical operation of the volumetric displacement dispenser device and performs the necessary operation for the device to fill the void occasioned by removal of wine from the wine container. The expansion of the volumetric displacement operative balloon 300 under pressure also operates to pressure the dispensing of wine from the container.

Air/gas check valve 140, liquid check valve 250 and loop seal 254 in liquid discharge tube 400 are essential for operation of the volumetric displacement operative balloon 300. As operative elements, the check valves and loop seal are essential for the physical operation of the volumetric displacement operative balloon 300 by controlling and preventing backflow of gases and liquids to control flow of respective gases and liquids.

Further referring to FIGS. 1-5, the figures illustrate preferred embodiments of a volumetric displacement dispenser in accordance with the present invention.

Referring to FIGS. 1-5, two embodiments of a volumetric displacement dispenser are generally shown at 10. In FIG. 1, volumetric displacement dispenser 10 comprises cap 105 of cap assembly 100 for a first embodiment, and an alternative cap-external gas 110 for a second embodiment in FIG. 3. Cap assembly 100 (FIG. 1) further comprises air pump/air vent assembly 120 connected to air pump/air vent body 122 (FIG. 2A) of pressure tube inlet 510, which is subsequently routed through a fitted bore in ported stopper 600 (FIGS. 2A-2B) by air/gas pressure tube 500 (FIGS. 1-5) and connected to volumetric displacement device operative balloon 300 (FIG. 1) by upper retaining clip 310 (FIG. 4). Retaining clip 310 also retains volumetric displacement device casing 320 in position encompassing operative balloon 300.

The cap-external gas 110 of alternative embodiment (FIGS. 3-5) comprises pressure tube inlet 510, has liquid dispensing valve 200, dispensing valve operator 230 (FIGS. 4, 5), liquid spigot 210 (FIGS. 4-5) and dispensing liquid outlet 220 (FIGS. 4-5) connected to liquid discharge tube 400, which is subsequently routed through a fitted bore in ported stopper 600 (FIGS. 3-5) wherein liquid discharge tube 400 (FIG. 3) extends into the bottle 50 in contact with the vessel's contents.

In operation, volumetric displacement dispenser 10 is placed into a bottle 50. The ported stopper 600 (FIGS. 1-5) is securely seated to provide an air tight and air-pressure tight seal within the neck of the bottle 50, wherein cap assembly 100 and cap with cap 105 and cap-external gas 110 cover the outer surface of the neck of the bottle 50.

The volumetric displacement dispenser 10 may be inserted into any vessel or container, irrespective of the configuration wherein evacuation of air or maintenance of an inert environment is desirable for the preservation of the fluids contained therein. In preferred embodiments, cap assembly 100 with cap 105 and cap-external gas 110 may have an outer flexible sealing ring about the base of cap assembly 100 with cap 105 and cap-external gas 110 to engage the outer surface of the neck of the bottle 50 thereby forming a seal to prevent contaminants from entering the bottle 50 or the internals of cap assembly 100 with cap 105 and cap-external gas 110. The outer sealing ring may be comprised of any polymeric, elastomer material including but not limited to rubber, plastic, copolymer compounds or cork. In another embodiment, the outer sealing ring may be an integral element of the cap assembly.

The volumetric displacement dispenser 10 construction material can be selected from a group consisting of polymers, polymer alloys, non-ferrous metals, ferrous metals, carbon fiber, carbon powder, silicone polymers, elastomers, glass, ceramics and combinations thereof. The tubing can be transparent to allow visual confirmation of the operation of the device. When indicated use of the volumetric displacement dispenser 10 is for food or sanitary usage, compliance with U.S. Department of Agriculture (USDA) or U.S. Food and Drug Administration (FDA) regulations regarding the selected materials of construction is necessary. The volumetric displacement dispenser may be manufactured by any technique recognized in the Mechanical Arts but not limited to molding, casting, forging, sintering, spinning, polishing, plating and any combinations thereof which are capable of yielding a finished product satisfying regulatory guidelines governing the use of such products, i.e. FDA, USDA, etc.

In a first embodiment of FIG. 2A, the user applies a pressure source of compressed air by operation of air pump piston shaft 150 and air pump/air vent assembly 120 to air/gas check valve 140. Compressed air flows through air check valve flapper 142 to pressure tube inlet 510 to air/gas pressure tube 500 into volumetric displacement operative balloon 300. Liquid check valve 250 prevents backflow of gases. Application of air pressure to operative balloon 300 will cause flow of wine from liquid spigot 210.

In an alternate embodiment of FIG. 1 (FIG. 2B), liquid spigot 210 is connected to vertical loop seal 254 wherein the loop seal comprises at least one 360° loop of tubing for 360° vertical circular flow. Loop seal 254 acts to control outflow of liquid spigot 210 and acts to prevent backflow of gases into the container/vessel.

In a second embodiment (FIGS. 3-5), the user applies a pressure source of an external compressed inert gas that is greater than the atmospheric pressure to the pressure tube inlet 510 using a coupling connector (not shown), which protrudes vertically from top surface of cap-external gas 110. Pressure tube inlet 510 is retained in position as cap-external gas 110 by retainer 124. The compressed gas flows through air/gas check valve 140 to air/gas pressure tube 500 into volumetric displacement operative balloon 300. Concurrently, the user opens liquid dispensing valve 200 on the dispensing liquid outlet 220 to liquid spigot 210.

In the second embodiment (FIGS. 3-5), a liquid may be employed in lieu of a gaseous pressure source. This allows the air or other gases in the bottle 50 to be purged through perforated tube 400 while the volumetric displacement operative balloon 300 inflates by the liquid pressure and occupies the void space in the bottle 50 thus forcing the liquid up perforated tube 400 through liquid check valve 250 and out liquid spigot 210, until the user closes the liquid dispensing valve 200 (FIGS. 3-5). When the user decants the contained liquid dispensing valve 200 is opened causing the internal and external pressure to equilibrate.

In the first embodiment, upon drawing fluid from the bottle 50, suction force is applied to the surface of the volumetric displacement operative balloon 300 in contact with the liquid resulting in balloon inflation by drawing in atmospheric air. The suction force on the volumetric displacement operative balloon 300 is transmitted to the air/gas check valve 140 by pressure tube inlet 510 to air pump/air vent assembly 120. Air/gas check valve 140 is drawn open by the negative suction force wherein air is admitted in a volume directly corresponding to the volume of liquid decanted. This process is repeated by the user until the volume of liquid in the bottle 50 is decanted. In another embodiment, air/gas check valve 140 may comprise a mechanism for temperature compensation, wherein the spring tension of the valve closure may respond to colder temperatures by reducing the spring tension, and conversely by increasing the spring tension upon exposure to increases in temperature.

In the second embodiment, application of additional measured amounts of compressed gas results in added decantation of wine from the container by inflation of the operative balloon.

Further, referring to FIGS. 1-5, additional details of the volumetric displacement dispenser are generally shown. Referring to cap-air pump 105 of cap assembly 100 (FIGS. 1, 2A-2B) and cap-external gas 110 (FIGS. 3-5) each have a given shape, height, circumference, a top, a base, a contiguous circumferential side, an inside surface and an outside surface. Air pump/air vent assembly 120 is connected to cap-air pump 105 of cap assembly 100 underside by retainer 124 (FIGS. 2A-2B). Air pump/air vent body 122 (FIG. 2A) has an inlet (not shown). Retainer 124 (FIGS. 2A-2B, 5), is in communication with air/gas check valve 140 (FIGS. 2A, 5) wherein air/gas check valve 140 (FIGS. 2A, 4) is disposed to operation by the user and is connected to pressure tube inlet 510 (FIG. 2A); and air/gas pressure tube 500 (FIGS. 1-5), subsequently terminating in volumetric displacement operative balloon 300. The volumetric displacement operative balloon 300 with capacity to yield to a minimum suction force or vacuum has resistance to tearing and rupture in event of over-pressurization, moderate impulse forces or cyclic forces. The pressure tube inlet 510 is connected to air/gas pressure tube 500 by inlet air connector 132 (FIG. 1). The volumetric displacement operative balloon 300 is connected to air/gas pressure tube 500 by retaining clip 310. Both air/gas pressure tube 500 and liquid discharge tube 400 are routed through ported stopper 600 with each tube borehole in substantial agreement with the outside diameter of each tube. Thereby, a pressure and watertight seal is facilitated to provide isolation of the contents of the bottle 50 or other similar container from the environment.

In alternative embodiments of cap assembly 100 and cap-external gas 110 (FIGS. 2A-2B, 3-5), air/gas check valve 140 can comprise a connection means such as but not limited to a nipple, union, hose barb, solder joint, coupling and any other fitting known in the Mechanical Arts to permit a number of volumetric displacement dispensers' inlets to be connected to a manifold. Compressed air or an inert gas can be supplied as required through the manifold to inflate the volumetric displacement operative balloon 300 (FIG. 3). This alternative embodiment requires that the manifold has at least one demand valve having an adjustable set pressure range for predetermined pressure.

Referring to FIGS. 1 and 3, the volumetric displacement operative balloon is shown as 300. The volumetric displacement operative balloon 300 comprises a flexible membrane of a given shape, length and diameter, having a first end, a second end and having at least one opening in the first end, which is responsive to a suction force or vacuum at minimal increments developed by a suction force or vacuum from removal of fluid, wherein a corresponding enlargement of the membrane occurs. The volumetric displacement operative balloon 300 may comprise a membrane having a configuration in substantial agreement with the container in which the volumetric displacement dispenser 10 is utilized such that the entire volume of the container is occupied by the volumetric displacement operative balloon 300 upon inflation.

The volumetric displacement operative balloon 300 membrane typically is of varying gauge corresponding to the length and symmetry of the container/vessel. Upon inflation, the volumetric displacement operative balloon 300 expands. As stated earlier, the volumetric displacement operative balloon 300 comprises materials of construction required by the U.S. Food and Drug Administration for food grade polymers and elastomers, and must not evidence wear or deterioration from contact with the fluid or the container/vessel.

Specifically, referring to FIG. 2A, illustrating a first embodiment, cap-air pump 105 of cap assembly 100 is shown in accordance with the present invention. Cap-air pump 105 encloses air pump/air vent assembly 120, air pump/air vent body 122, retainer 124, liquid spigot 210 and ported stopper 600.

Air pump/air vent assembly 120 (FIG. 2A) comprises air pump/air vent body 122 with an air inlet (not shown) in the topside of cap-air pump 105. Retainer 124 secures the air pump/air vent assembly 120 to cap-air pump 105 while simultaneously serving as a guide for piston 126 in the bore of air pump/air vent body 122. Piston 126 is maintained in spaced agreement with the internal walls of air pump/air vent body 122. The downward axial travel of piston 126 is opposed by piston spring 128, having a spring constant and force in direct contact with the piston 126.

In operation, a method of use of the instant invention is detailed for the user to employ the following sequence to replace an existing container stopper with the volumetric displacement dispenser 10 (FIGS. 1-5) in the following procedure:

(a) Remove the original container seal.

(b) Determine if volumetric displacement operative balloon 300, casing 320 and liquid discharge tube 400 can be inserted into the container opening and if cap assembly 100 will seal the container opening.

(c) Insert volumetric displacement operative balloon 300 and liquid discharge tube 400 into the container, taking care not to disconnect pressure tube inlet 510 and air/gas pressure tube 500 from inlet air connector 132 and discharge tube connector 232.

(d) Insert cap assembly 100 into the container opening until the cap assembly base is firmly seated against the top of the container opening.

(e) Insure that cap assembly 100 fits tightly into the container.

(f) Inflate the volumetric displacement operative balloon 300 until a small volume of the dispensable liquid is decanted. Transparent tubing in cap assembly 100 can provide visual confirmation that the system is liquid full.

(g) Close liquid dispensing valve 200 if applicable.

(h) In the event that the volumetric displacement operative balloon 300 loses contact with the dispensable liquid, the sequence is repeated.

(i) Open liquid dispensing valve 200 and withdraw liquid from the container. The user should observe that the volumetric displacement operative balloon 300 expands, maintaining contact with the dispensable liquid.

A table of reference characters used for parts of the volumetric displacement dispenser follows.

TABLE OF REFERENCE CHARACTERS FOR PARTS
OF THE VOLUMETRIC DISPLACEMENT DISPENSER

| Reference | |
|---|---|
| Character | Part Term |
| 10 | VOLUMETRIC DISPLACEMENT DISPENSER |
| 50 | BOTTLE |
| 100 | CAP ASSEMBLY |
| 105 | CAP-AIR PUMP |
| 110 | CAP-EXTERNAL GAS |
| 120 | AIR PUMP/AIR VENT ASSEMBLY |
| 122 | AIR PUMP/AIR VENT BODY |
| 124 | RETAINER |
| 126 | PISTON |
| 128 | PISTON SPRING |
| 132 | INLET AIR CONNECTOR |
| 140 | AIR/GAS CHECK VALVE |
| 142 | AIR/GAS CHECK VALVE FLAPPER |
| 150 | AIR PUMP PISTON SHAFT |
| 200 | LIQUID DISPENSING VALVE |
| 210 | LIQUID SPIGOT |
| 220 | DISPENSING LIQUID OUTLET |
| 230 | DISPENSING VALVE OPERATOR |
| 232 | DISCHARGE TUBE CONNECTOR |
| 250 | LIQUID CHECK VALVE |
| 252 | LIQUID CHECK VALVE SEAT |
| 254 | LOOP SEAL |
| 300 | VOLUMETRIC DISPLACEMENT OPERATIVE BALLOON |
| 310 | RETAINING CLIP |
| 320 | VOLUMETRIC DISPLACEMENT DEVICE CASING |
| 400 | LIQUID DISCHARGE TUBE |
| 500 | AIR/GAS PRESSURE TUBE |
| 510 | PRESSURE TUBE INLET |
| 600 | PORTED STOPPER |

In summary, the instant invention comprises a volumetric displacement dispenser for bottles for dispensing measured quantities with exclusion of air from contents of the dispensing bottle, the liquid dispenser embodied as a bottle cap assembly wherein said bottle cap assembly, as a volumetric displacement dispenser, in combination, comprises: (a) a separate cap for said bottle cap assembly, (b) a means for a source of compressed gas, (c) an air/gas check valve, (d) a liquid control means, (e) an expandable operative polymer balloon, (f) a casing of polymer material to encase said expandable operative polymer balloon, (g) a ported stopper to seat said bottle cap assembly in neck of dispensing bottle, and (h) associated polymer tubes, retaining clips and tubing connectors.

The means for a source of compressed gas can comprise a manually operated air pump, which comprises a piston shaft, a piston, a piston spring, a retainer for the air pump/air vent body, an air pump/air vent body assembly and an air pump/air vent body.

The means for a source of compressed gas can comprise an external source of compressed gas for attachment to an external pressure tube inlet by coupling connector inserted through said separate cap for said bottle cap assembly and held in place by a retainer. The source of compressed gas can comprise a source of an inert gas comprising a cylinder of compressed gas.

The air/gas check valve comprises an air/gas check valve flapper positioned in the air/gas pressure tube.

The liquid control means comprises: (a) a liquid check valve seat, (b) a liquid check valve, (c) a perforated liquid discharge tube, (d) a liquid dispensing valve, (e) dispensing valve operator, (f) a dispensing liquid outlet, and (g) a liquid spigot.

The liquid control means comprises: (a) a perforated liquid discharge tube and (b) a vertical loop seal in said liquid discharge tube wherein said vertical loop seal consists of at least one 360° loop of tubing for at least one 360° circular loop of vertical liquid flow.

The ported stopper has fitted bores, which route tubes through said stopper and said stopper is sized to securely seat within neck of the dispensing bottle.

A method of use of the instant invention to replace an existing container stopper with the volumetric displacement dispenser with exclusion of air from contents of the dispensing bottle comprises the following procedure:

(a) Remove the original container seal.

(b) Determine if the operative balloon encased in the balloon casing and liquid discharge tube is insertable into the container opening and if the dispenser portal stopper seals the container opening.

(c) Insert the operative balloon encased in the balloon casing and liquid discharge tube into the container opening, taking care not to disconnect the pressure tube inlet and air/gas pressure tube from the inlet air connector and discharge tube connector.

(d) Insert the cap assembly into the container opening until the cap assembly ported stopper is firmly sealed in the container opening.

(e) Insure cap assembly fits tightly in the container.

(f) Inflate the operative balloon until a small volume of liquid from the container is decanted and the operative balloon contacts the surface of the dispensable fluid.

(g) In the event the operative balloon loses contact with the contained fluid, the sequence is repeated.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

What is claimed is:

1. A liquid dispenser for bottles for dispensing measured quantities with exclusion of air from contents of the dispensing bottle, the liquid dispenser embodied as a bottle cap assembly wherein said bottle cap assembly as a volumetric displacement dispenser, in combination, comprises:
(a) a separate cap for the bottle cap assembly,
(b) a means for a source of a compressed gas,
(c) an air/gas check valve,
(d) a liquid control means,
(e) an operative expandable polymer balloon,
(f) a casing of polymer material to encase said operative expandable polymer balloon, and
(g) a ported stopper to seat said bottle cap assembly in neck of dispensing bottle.

2. The liquid dispenser of claim 1 wherein means for a source of a compressed gas comprises a manually operated air pump.

3. The manually operated air pump of claim 2 which comprises a piston shaft, a piston, a piston spring, a retainer for an air pump/air vent body, an air pump/air vent body assembly, an air pump/air vent body.

4. The liquid dispenser of claim 1 wherein means for a source of a compressed gas comprises an external source of compressed gas by coupling connector for attachment to an external pressure tube inlet inserted through said separate cap for said bottle cap assembly and held in place by a retainer.

5. The source of compressed gas of claim 4, which comprises a source of an inert gas comprising a cylinder of, compressed gas.

6. The liquid dispenser of claim 1 wherein air/gas check valve comprises an air/gas check valve flapper positioned in the air/gas pressure tube.

7. The liquid dispenser of claim 1 wherein liquid control means comprises:
(a) a liquid check valve seat,
(b) a liquid check valve,
(c) a perforated liquid discharge tube,
(d) a liquid dispensing valve,
(e) a dispensing valve operator,
(f) a liquid spigot, and
(g) a dispensing liquid outlet.

8. The liquid dispenser of claim 1 wherein liquid control means comprises:
(a) a perforated liquid discharge tube,
(b) a vertical loop seal in said liquid discharge tube wherein said vertical loop seal consists of at least one 360° loop of tubing for at least one 360° circular loop of vertical liquid flow.

9. The liquid dispenser of claim 1 wherein said ported stopper has fitted bores, which route tubing through stopper and said stopper is sized to securely seat within neck of the dispensing bottle.

10. A method of use of the instant invention to replace an existing container stopper with the volumetric displacement dispenser with exclusion of air from contents of the dispensing bottle comprises the following procedure:
(a) Remove the original container seal.
(b) Determine if an operative balloon encased in a balloon casing and a liquid discharge tube are insertable into the container opening and if the dispenser ported stopper seals the container opening.
(c) Insert the operative balloon encased in the balloon casing and liquid discharge tube into the container opening, taking care not to disconnect the pressure tube inlet and pressure tube from the inlet air connector and discharge tube connector.
(d) Insert the cap assembly into the container opening until the cap assembly ported stopper is firmly seated in the container opening.
(e) Insure cap assembly fits tightly in the container.
(f) Inflate the operative balloon until a small volume of liquid from the container is decanted and the operative balloon contacts the surface of the dispensable fluid.
(g) In the event the operative balloon loses contact with the container and/or the contained fluid, the sequence is repeated.
